(19) United States
(12) Patent Application Publication
(10) Pub. No.: US 2011/0038587 A1
(43) Pub. Date: Feb. 17, 2011

(54) MULTI-CLAD OPTICAL FIBER

(76) Inventors: Leslie Brandon Shaw, Woodbridge, VA (US); Jasbinder S. Sanghera, Ashburn, VA (US); Daniel J. Gibson, Greenbelt, MD (US); Ishwar D. Aggarwal, Fairfax Station, VA (US); Frederic H. Kung, Alexandria, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/539,047

(22) Filed: Aug. 11, 2009

(51) Int. Cl. G02B 6/036

(52) U.S. Cl. 385/127

(57) ABSTRACT

A chalcogenide multi-clad optical fiber having a core, a first cladding and one or more subsequent claddings including a chalcogenide glass. The optical fiber may be capable of transmitting visible and inferred light and may be used for a wide variety of semiconductor applications.

### BACKGROUND OF THE INVENTION

1. Field of the Invention

The present invention relates to the field of multi-clad optical fibers. In particular the present invention relates to chalcogenide multi-clad fibers.

2. Description of the Related Technology

Multi-clad optical silica based fibers are widely available and well known in the art. For example, rare earth doped silica optical fibers having a double-cladding structure are frequently used to construct lasers, wherein light is pumped into and substantially retained within the rare earth core of the optical fiber. The core of these fibers is typically about 4 μm to about 20 μm in diameter and doped with a rare earth element so that the spatial profile of the laser emission is single mode at the lasing wavelength. The core is surrounded by a first cladding, typically about 100 μm to about 400 μm in diameter, having a refractive index designed to contain light within the core. The silica-based glasses comprising the core, first cladding and any subsequent claddings must have refractive indices different from the glass in adjacent regions in order to guide light. This is typically accomplished by adjusting the glass composition by incorporating dopants or by introducing “air holes” in the glass to form a microstructured cladding region.

During laser pumping, the pump light is launched into the first cladding and interacts with the rare earth doped core; the light becomes absorbed by and excites the rare earth to enable laser emission. Typically this first cladding is non-circularly symmetric to minimize modes which do not overlap the core of the fiber, hindering absorption of the pump light, and is generally configured to have a square or D shape. The inner cladding is surrounded by a second outer cladding having a refractive index designed to contain the pump light in the first inner cladding. In general, the first cladding is typically constructed from solid or microstructured silica based glass, and the second cladding is constructed from solid silica based glass, microstructured silica based glass or a polymeric material. For example, a core may be surrounded by a first cladding consisting of a solid silica based glass that is enclosed by a second cladding consisting of a microstructured region. In this embodiment, the first solid silica based glass facilitates in guiding light in the core, and the second microstructured region provides guidance in the first cladding.

Silica based optical fibers, however, however have a limited transmission range. In general, silica fibers only enable the transmission of visible light and are typically limited to wavelengths of about 1 μm to about 2 μm. Additionally, the outer claddings of these fibers when constructed of polymer, are typically inadequate for high power handling. Consequently, the polymeric outer sheath covering these fibers is compromised and may melt upon interacting with the scattered pump light.

Recently, new materials, such as chalcogenide glasses, are being investigated to improve the properties of current optical fibers. For example, U.S. Pat. No. 5,879,426 (Sanghera) discloses a single clad optical fiber wherein the core and cladding may be fabricated from chalcogenide glass. Sanghera, however, does not teach a multi-clad chalcogenide optical fiber. The disclosed single clad fiber has limited applications and cannot be used to construct lasers. Furthermore, the fabrication of thin outer claddings, particularly chalcogenide claddings, having a higher refractive index than that of a first chalcogenide cladding is difficult to manufacture. Not only must the material index differences between the core, first cladding, and second cladding compositions be considered, but the glass transition temperatures and draw temperatures of these compositions must also be addressed. Typically, the dopants and air holes added to obtain the required refractive index differences also impact the draw temperatures of the glasses such that the draw temperature for the core, first cladding and second cladding may differ by about 10° C. to about 20° C. or more. Such draw temperature differences are significant, given the typically low, compared to silica, draw temperatures used for these glasses and the typically strong, when compared to silica, temperature dependence of their viscosities. It is therefore often difficult or impossible to co-draw these glass compositions into fiber while maintaining the integrity of the glasses.

Additionally, other publications, such as U.S. Patent application publication no. 2005/0254764 (Chatigny) disclosing a double-clad optical fiber having a chalcogenide glass core and U.S. Patent application publication no. 2008/0199135 (Proulx) disclosing a double-clad optical fiber having a chalcogenide glass first cladding, do not teach a multi-clad optical fiber having at least a chalcogenide glass core and chalcogenide glass first cladding with enhanced fiber optic properties. Therefore, there is a need to develop multi-clad chalcogenide optical fibers having enhanced structural integrity and optical properties.

### SUMMARY OF THE INVENTION

The present invention is directed to a multi-clad optical fiber. In a first aspect, the optical fiber has a multi-clad structure including a core including a chalcogenide glass, a first cladding including a chalcogenide glass disposed about the core and at least a second cladding disposed about said first cladding.

In a second aspect, the optical fiber has a core including a chalcogenide glass and an opening, a first cladding including chalcogenide glass disposed about the core, and at least a second cladding including chalcogenide glass disposed about the first cladding, wherein the second cladding has a lower refractive index than the first cladding.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a multi-clad chalcogenide fiber having a solid core constructed from a chalcogenide glass, a first cladding constructed from microstructured chalcogenide glass having a series of openings surrounded by solid glass therebetween, a second solid chalcogenide glass cladding and a third solid chalcogenide glass cladding.

FIG. 2 is a double-clad chalcogenide fiber having a solid chalcogenide glass core, and first and second solid chalcogenide glass cladding layers.

FIG. 3 shows a graph of refractive index as a function of wavelength for an arsenic sulfide selenium glass system that may be used to construct the core, first cladding and/or second cladding of the multi-clad optical fiber of certain embodiments of the present invention.

FIG. 4 shows a multi-clad chalcogenide fiber having a hollow core, a first cladding constructed from microstructured chalcogenide glass having a series of longitudinal openings surrounded by chalcogenide glass therebetween, a solid second cladding constructed from a chalcogenide glass, and a solid third cladding constructed from a chalcogenide glass.

FIG. 5 shows a multi-clad chalcogenide fiber having a solid core constructed from a chalcogenide glass, a first solid chalcogenide glass cladding and a second cladding constructed from microstructured chalcogenide glass having a series of longitudinal openings surrounded by chalcogenide glass therebetween.

FIG. 6 shows a multi-clad chalcogenide fiber having a solid core constructed from a chalcogenide glass, a first solid chalcogenide glass cladding, a second chalcogenide glass cladding, and a third cladding constructed from microstructured chalcogenide glass having a series of longitudinal openings surrounded by chalcogenide glass therebetween.

### DETAILED DESCRIPTION OF THE PREFERRED EMBODIMENT(S)

For illustrative purposes, the principles of the present invention are described by referencing various exemplary embodiments. Although certain embodiments of the invention are specifically described herein, one of ordinary skill in the art will readily recognize that the same principles are equally applicable to, and can be employed in other systems and methods. Before explaining the disclosed embodiments of the present invention in detail, it is to be understood that the invention is not limited in its application to the details of any particular embodiment shown. Additionally, the terminology used herein is for the purpose of description and not of limitation. Furthermore, although certain methods are described with reference to steps that are presented herein in a certain order, in many instances, these steps may be performed in any order as may be appreciated by one skilled in the art; the novel method is therefore not limited to the particular arrangement of steps disclosed herein.

It must be noted that as used herein and in the appended claims, the singular forms “a”, “an”, and “the” include plural references unless the context clearly dictates otherwise. Thus, for example, reference to “a cladding” may include a plurality of claddings and equivalents thereof known to those skilled in the art, and so forth. As well, the terms “a” (or “an”), “one or more” and “at least one” can be used interchangeably herein. It is also to be noted that the terms “comprising”, “including”, “having” and “constructed from” can be used interchangeably.

For purposes of the present invention, “chalcogenide glass,” as used herein refers to a vitreous material composed of one or more chalcogen elements, i.e. Group VI elements of the Periodic Table. Exemplary chalcogen elements may include sulfur, selenium, tellurium or combinations thereof, such as sulfide selenide, sulfide tellurium or tellurium selenium systems. Sulfide fibers, such as As₂S₃, enable transmission over a range of wavelengths of about 1-6 μm, and the addition of heavier chalcogenide elements, such as tellurium, may increase the transmission window to include wavelengths longer than 10 μm. In general, the presence of tellurium in the glass composition increases transmission in the infrared region. Glasses containing high levels of tellurium may enable transmission of wavelengths in the 3-12 μm region.

One or more dopants may be added to the chalcogenide glass to enhance the optical properties of the fiber. Exemplary dopants may include, gallium, rare earth elements, halogen elements and/or transition metals. In an exemplary embodiment, the chalcogenide glass may be selected from arsenic sulfide, arsenic selenide, germanium arsenic sulfide, germanium arsenic selenide, arsenic sulfide selenide, germanium arsenic sulfide selenide, arsenic telluride, germanium arsenic telluride, arsenic tellurium selenide, arsenic sulfide telluride, germanium arsenic tellurium selenide and germanium arsenic sulfide telluride. Additionally, gallium and/or one or more rare earth elements may be used as an additional dopant in any of the aforementioned list of exemplary chalcogenide glass systems. Exemplary rare earth elements that may be used as dopants may include optically active elements, such as lanthanum, terbium, praseodymium, neodymium, erbium, cerium, dysprosium, holmium, thulium, ytterbium, gadolinium or mixtures thereof.

In addition to chalcogen elements, the chalcogenide glass may optionally further include one or more glass stabilizers, such as one or more halides. Exemplary halides may include chlorine, bromine, fluorine and iodine. Glasses containing both chalcogen and halogen elements are commonly termed chalcohalide glasses. In another exemplary embodiment, the chalcogen elements may be mixed with one or more Group IV and/or Group V elements to form conventional compound glasses.

In an exemplary embodiment, the doped and undoped chalcogenide glasses of the present invention may contain at least about 25 mole percent, preferably, at least about 50 mole percent, of one or more chalcogens. In an exemplary embodiment, the chalcogenide glass may contain at least about 25 mole percent, preferably, at least about 50 mole percent, of sulfur, selenium, tellurium or combinations thereof. In an exemplary embodiment the dopants may be present in an amount of from about 0% up to about 5% by weight of the chalcogenide glass, and the optical stabilizers may be present in an amount of from about 0% up to about 15% by weight of the chalcogenide glass.

The aforementioned chalcogenide glasses may be used to construct the core, first cladding, subsequent claddings or combinations thereof, of the multi-clad optical fiber of the present invention. The refractive index of each of the core and claddings depends on the chemical composition and/or structure of the chalcogenide glass from which is constructed. The chemical composition and/or structure of the core, first cladding, second cladding and any subsequent claddings, however, must be different from one another so that the core and one or more claddings have different refractive indexes. In an exemplary embodiment, the structure and/or chemical composition of core, first cladding, second cladding and any subsequent claddings are different such that the refractive index of each layer decreases the further away the cladding is positioned relative to core. The refractive indexes of the core and claddings can be changed by varying the chemical composition of the glass composing the core or cladding, by adding selective dopants and/or by changing the structure of the glass. For example, the refractive index may be modified by constructing a core or cladding from a microstructured glass rather than solid glass or by changing the number of openings in or air-fraction of the microstructured glass.

For purposes of the present invention, “multi-clad” or “multi-cladding,” as used herein refers to a fiber having two or more claddings, including, but not limited to, double-clad and triple-clad optical fibers.

The present invention is directed to novel optical multi-clad chalcogenide fibers 100 and methods for making them. The multi-clad chalcogenide fiber 100 may have a core 1, a first cladding 3 and a second cladding 5, each of which may be constructed from one or more chalcogenide glasses. Capable of transmitting light in the visible and/or infrared range, multi-clad fiber 100 may have enhanced fiber optic properties, including optical amplification and light stripping or guiding. In an exemplary embodiment, multi-clad fiber 100 may be constructed using a rod and tube fabrication method or a multi-crucible fabrication method. It is envisioned that the resultant multi-clad fiber 100 may be used for a wide variety of optical applications and may be particularly suitable for constructing lasers and optical sensors.

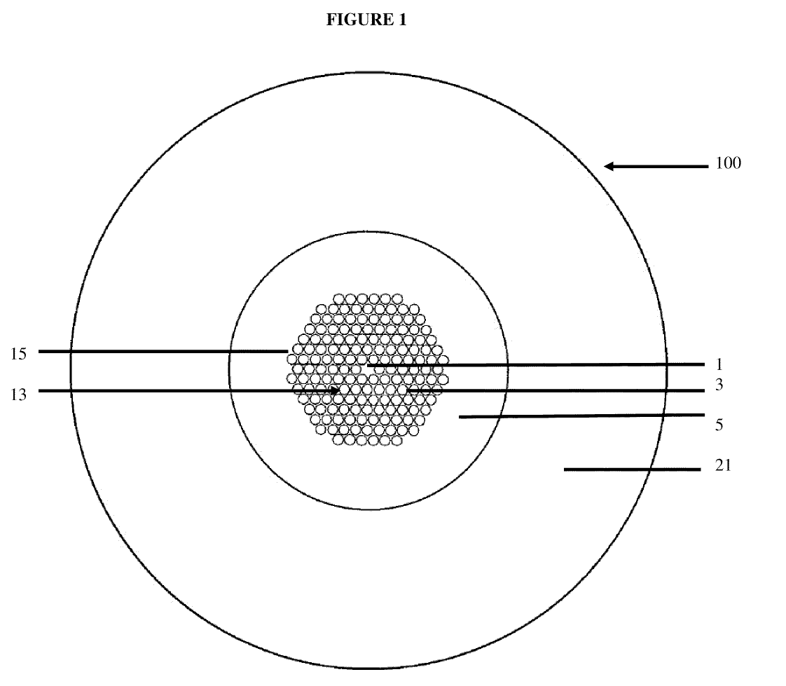

As shown in the exemplary embodiment of FIG. 1, multi-clad fiber 100 may have a core 1 including one or more transparent chalcogenide glasses. In one exemplary embodiment, core 1 may be fabricated from one or more undoped chalcogenide glasses. In an alternative embodiment, core 1 may include one or more chalcogenide glasses doped with one or more compounds to enable the use of a multimode pump for pumping the fiber by launching the pump into the first cladding 3.

Core 1 may have any shape, dimension, structure or configuration suitable for transmitting light. In an exemplary embodiment, core 1 may have any geometric cross-sectional shape, including a circular, elliptical, D-shape, triangular, square, rectangular or hexagonal cross-section, and may have a diameter of about 1 μm to about 50 μm. In an exemplary embodiment, core 1 may be able to transmit light over a range of wavelengths of from about 0.8 μm to about 14 μm, preferably, over a range of wavelengths of about 1 μm to about 12 μm and more preferably over a range of wavelengths of about 2 μm to about 5 μm.

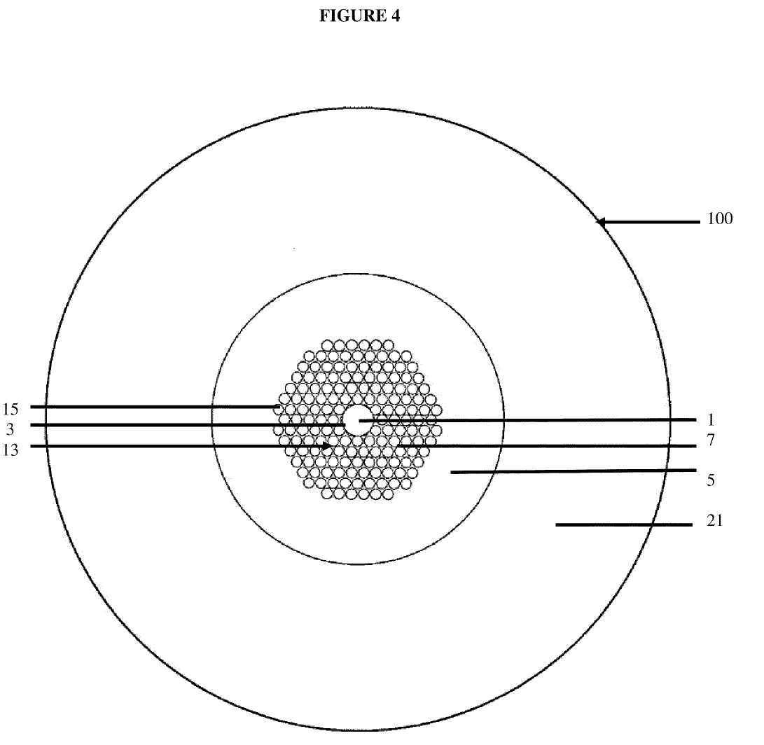

As shown in the exemplary embodiment of FIG. 1, multi-clad fiber 100 may have a core 1 that is substantially solid throughout its cross-section so as to have no or minimal cavities or openings. In an alternative embodiment of FIG. 4, multi-clad fiber 100 may have a hollow core 1 defined by a hollow center 7. In an exemplary embodiment, hollow core 1 may include a microstructured region 9 concentrically or asymmetrically disposed about a hollow center 7. Microstructured region 9 may have a plurality of longitudinal openings 11 concentrically or asymmetrically arranged about hollow center 7 so as to channel light into hollow center 7. Longitudinal openings 11 may be oriented parallel to the length of multi-clad fiber 100. In an exemplary embodiment, openings 11 may be arranged in one or more circular, elliptical, D-shaped, triangular, square, rectangular, hexagonal, honeycomb-shaped or any other geometrically shaped rows about hollow center 7. Microstructured region 9 may include 4-5 rows of openings 11 to establish a photonic band gap sufficient to channel light into hollow center 7. Alternatively, microstructured region 9 may include more or fewer than 4-5 rows. Openings 11 may have a circular, hexagonal, honeycomb or any other geometrically shaped cross-section. The diameter of openings 11 may range from a fraction of a micron to about 10 μm with a center-to-center spacing or periodicity of from about 1 μm to about 12 μm. The microstructured region 9 of the fiber, may have an air fill fraction, defined as the ratio of the space occupied by the openings to the total space occupied by the openings and the glass therebetween, which, may be calculated by measuring, in a transverse cross-section of the fiber, the ratio of the cross-sectional area of the individual openings to the cross-sectional area of the openings and the solid glass therebetween, i.e. the total cross-sectional area of the microstructured region 9 of the fiber. The air fill fraction of the microstructured region of the fiber should be from about 5% to about 99%, preferably, from about 40% to about 70%. In one exemplary embodiment, the openings may have a substantially circular cross-sectional shape, a regular non-varying periodicity defined as the distance from the center of one such opening to the center of the nearest adjacent opening, and may be oriented in a regular transverse hexagonal periodic arrangement. The air fill fraction may be defined by the constant π divided by the sine of sixty degrees multiplied by the square of the ratio of the radius to the periodicity.

A first cladding 3 may be disposed about core 1 to enhance the optical properties of multi-clad fiber 100. First cladding 3 may include one or more doped chalcogenide glasses, one or more undoped chalcogenide glasses or combinations thereof. Additionally, first cladding 3 may have any shape, dimension, structure or configuration conducive to enhancing the optical properties of fiber 100. In an exemplary embodiment, first cladding 3 may be concentrically or asymmetrically disposed about core 1 and may have a thickness of from about 1 μm to about 400 μm, preferably from about 10 μm to about 250 μm, more preferably, from about 10 μm to about 200 μm. Additionally, first cladding 3 may have any geometric cross-sectional shape, including a circular, elliptical, D-shaped, triangular, square, rectangular or hexagonal cross-section. In an exemplary embodiment, first cladding 3 may be able to transmit light over a wavelength range of from about 0.8 μm to about 14 μm, preferably, over a range of about 1 μm to about 12 μm and more preferably over a range of about 2 μm to about 5 μm.

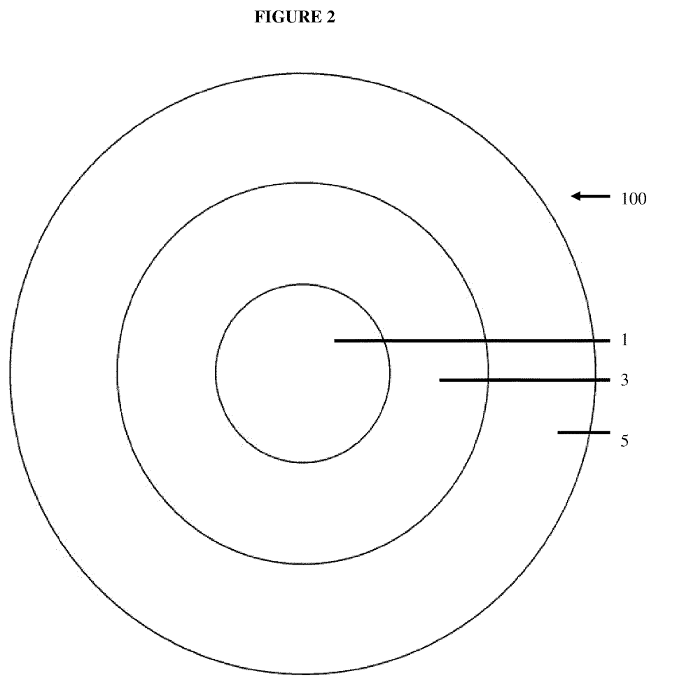

As shown in the exemplary embodiment of FIG. 2, first cladding 3 may have a structure that is substantially solid throughout its cross-section so as to have no or minimal openings. Alternatively, as shown in the exemplary embodiment of FIG. 1, first cladding 3 may have a microstructured region 13 having a plurality of longitudinal openings 15 that may be concentrically or asymmetrically arranged about core 1. Longitudinal openings 15 may be oriented parallel to the length of multi-clad fiber 100. In an exemplary embodiment, openings 15 may be arranged in one or more circular, elliptical, D-shape, triangular, square, rectangular, hexagonal, honeycomb or any other geometrically shaped rows about core 1. Each microstructured region 13 may include a plurality of rows of openings 15. Openings 15 may have a circular, hexagonal, honeycomb or any other geometrically shape cross-section. The diameter of openings 15 may range from about a fraction of a micron to about 10 μm with a center-to-center spacing or periodicity of from about 1 μm to about 12 μm. In the microstructured region 14 of the fiber, the air fill fraction should be from about 5% to about 99%, preferably, from about 40% to about 70%.

Multi-clad optical fiber 100 further includes a second cladding 5, including one or more chalcogenide glasses, disposed about first cladding 3. Second cladding 5 can function to trap light scattering from the core in first cladding 3. Additionally, second cladding 5 and subsequent claddings, when combined with a rare earth doped core 1 and an undoped first cladding 3, enable the optical fiber to form a laser. Specifically, second cladding 5 allows pump light to be launched into the first cladding 3 and absorbed by core 1.

Second cladding 5 may have a similar material and structural composition as that of first cladding 3. Specifically, second cladding 5 may include one or more doped chalcogenide glasses, one or more undoped chalcogenide glasses or combinations thereof. Additionally, second cladding 5 may have any shape, dimension, structure or configuration conducive to enhancing the optical properties of fiber 100. In an exemplary embodiment, second cladding 5 may be concentrically or asymmetrically disposed about first cladding 3 and may have a thickness of from about 1 μm to about 200 μm, preferably from about 10 μm to about 150 μm, more preferably, from about 10 μm to about 100 μm. Additionally, second cladding 5 may have any geometric cross-sectional shape, including a circular, elliptical, D-shaped, triangular, square, rectangular or hexagonal cross-section. In an exemplary embodiment, second cladding 5 may be able to transmit light over a range of wavelengths of from about 0.8 μm to about 14 μm, preferably, over a range of wavelengths of from about 1 μm to about 12 μm and more preferably over a range of wavelengths of from about 2 μm to about 6 μm.

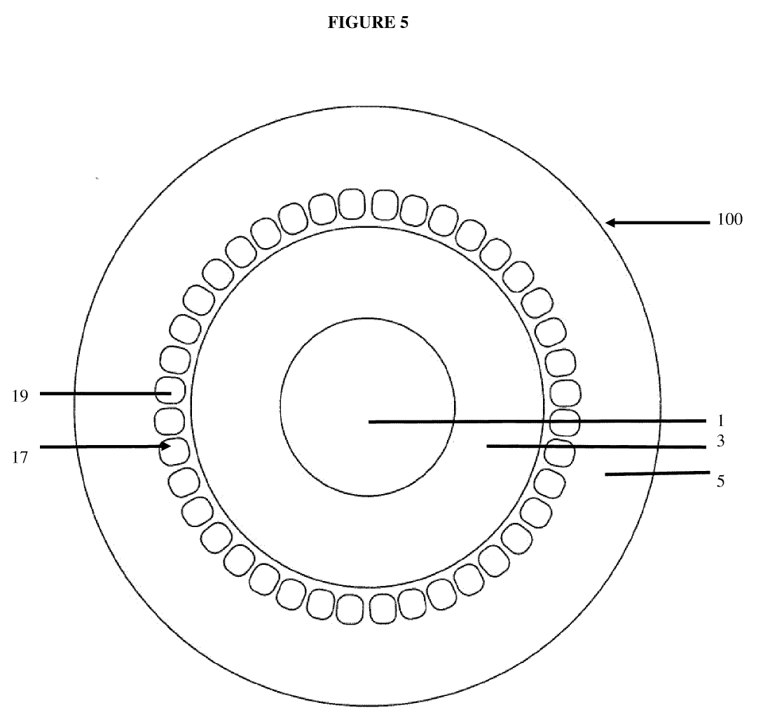

As shown in the exemplary embodiments of FIGS. 1-2, second cladding 5 and any subsequent claddings may have a structure that is substantially solid throughout the entire cross-sectional area so as to have no or minimal openings. Alternatively, as shown in the exemplary embodiment of FIG. 5, second cladding 5 and any subsequent claddings may have a microstructured region 17 having a plurality of longitudinal openings 19 that may be concentrically or asymmetrically arranged about first cladding 3 and/or core 1. Longitudinal openings 19 may be oriented parallel to the length of multi-clad fiber 100. Microstructured region 17 of second cladding 5 may have the same structure and configuration as the microstructured region 9 of first cladding 3.

Multi-clad optical fiber 100 may optionally further include one or more subsequent claddings having a similar material and structural configuration as that of first and second claddings 3, 5. In an exemplary embodiment, one or more of these subsequent claddings may include one or more doped chalcogenide glasses, one or more undoped chalcogenide glasses or combinations thereof. The subsequent claddings may be concentrically or asymmetrically disposed about second cladding 5 and may have an exemplary thickness of from about 1 μm to about 200 μm, preferably from about 10 μm to about 150 μm, more preferably, from about 10 μm to about 100 μm. In an exemplary embodiment, the total thickness of the overall multi-clad optical fiber 100 may be less than about 500 μm. Additionally, the subsequent claddings may have any geometric cross-sectional shape, including a circular, elliptical, D-shaped, triangular, square, rectangular or hexagonal cross-section. In an exemplary embodiment, these subsequent claddings may be able to transmit light over a range of wavelengths of from about 0.8 μm to about 14 μm, preferably, over a range of wavelengths of from about 1 μm to about 12 μm and more preferably over a range of wavelengths of from about 2 μm to about 5 μm.

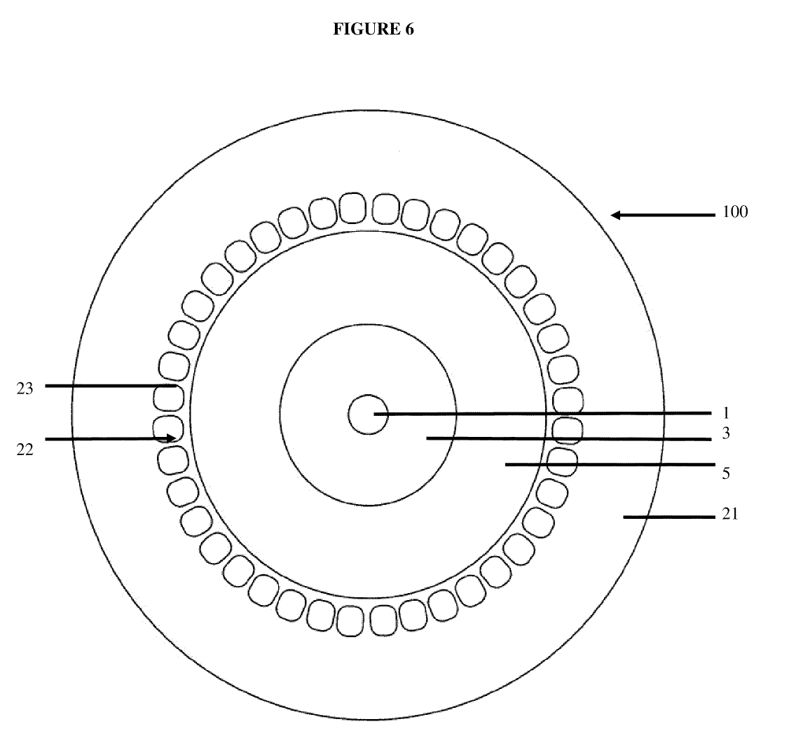

The subsequent claddings may have a structure that is substantially solid throughout the entire cross-section so as to have no or minimal openings. Alternatively, as shown in the exemplary embodiment of FIG. 6, the subsequent claddings may have a microstructured region 22 having a plurality of longitudinal openings 23 that may be concentrically or asymmetrically arranged about second cladding 5. Longitudinal openings 23 may be oriented parallel to the length of multi-clad fiber 100. This microstructured region 22 may have the same structure and configuration as the microstructured region 13, 17 of first and second claddings 3, 5.

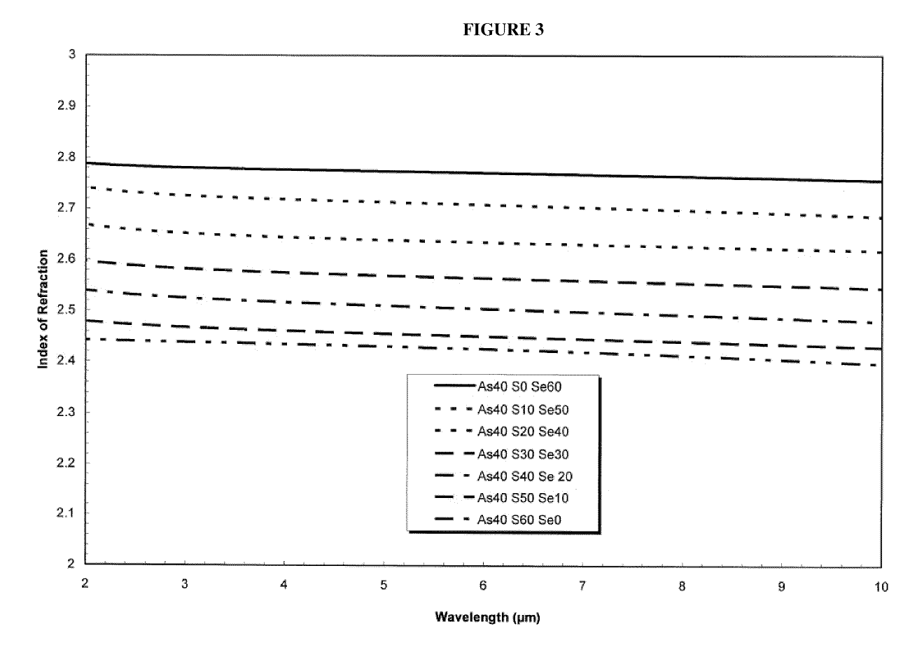

For solid core and subsequent solid claddings, the chemical composition of core 1, first cladding 3, second cladding 5 and any subsequent claddings are different from one another such that the refractive index of each cladding decreases the further away the cladding is positioned relative to core 1. For example, first cladding 3 may have a lower refractive index than core 1, and second cladding 5 may have a lower refractive index than first cladding 3. This variation in refractive index may be achieved by varying the molar ratios of the chalcogenide glass compounds of the core 1 and each claddings 3, 5, as shown in FIG. 3, and/or by using different chalcogenide glasses systems in fabricating core 1 and claddings 3,5. In an exemplary embodiment, the change in the refractive index between core 1 and first cladding 3, between first cladding 3 and second cladding 5, and between subsequent claddings may correspond to a change in the numerical aperture of from about 0.05 to about 0.8, preferably, from about 0.1 to about 0.6. For claddings which are composed of microstructured regions, the chemical composition between subsequent claddings may be of the same chemical composition of the core and claddings.

Optionally, the multi-clad fiber 100 may include a second cladding 5, or subsequent cladding having a refractive index greater than the antecedent cladding. A cladding with this property would strip light from the antecedent cladding. For example, first cladding 3 may have a lower refractive index than core 1, and second cladding 5 may have a higher refractive index than first cladding 3. This variation in refractive index may be achieved by varying the molar ratios of the chalcogenide glass compositions of the core 1 and each claddings 3, 5 and/or by using different chalcogenide glass systems in fabricating core 1 and claddings 3, 5 and/or by incorporating longitudinal openings 15, 19 in one or more claddings 3, 5 to form a microstructured cladding. The exemplary embodiment shown in FIG. 1 shows a chalcogenide glass core 1, first cladding 3 having a plurality of longitudinal openings 15 and a chalcogenide glass disposed between the openings 15 and having a refractive index lower than the core 1, a second cladding 5 comprised of a chalcogenide glass and having a refractive index higher than first cladding 3 and a third cladding 21 comprised of a chalcogenide glass and having a refractive index lower than second cladding 5. The effective refractive index of a microstructured cladding having longitudinal openings surrounded by glass is approximately the weighted average of the refractive index of the openings and the glass therebetween when the diameters of the openings are on the same scale as the wavelength of light being guided.

Optionally, the multi-clad fiber 100 may further include a protective sheath disposed about the outermost cladding to facilitate handling. In an exemplary embodiment, the protective sheath may be a hydrophobic or hydrophilic polymeric material coating. Exemplary polymeric materials may include low density polyethylene, polydimethylsiloxane, polyacrylate or combinations thereof.

The multi-clad optical fibers 100 of the present invention may be fabricated using any conventional means, such as tube casting, rod etching, core drilling, extrusion, tube stacking and multi-crucible drawing. In an exemplary embodiment, multi-clad optical fiber 100 may be constructed using a rod and tube method that involves first fabricating a chalcogenide glass rod for the fiber core and two or more chalcogenide glass tubes for the fiber claddings. The rod and tubes may be fabricated either as a substantially solid chalcogenide glass structure or may be fabricated as a microstructured chalcogenide glass.

To create microstructured rods and tubings, the precursor chemicals for synthesizing chalcogenide glass may be placed in pre-cleaned ampoules. The ampoules may be pressurized to about 10⁻⁵ Torr, sealed and subsequently heated to about 800° C. The contents of the ampoule may then react over a period of about 10 hours before being further distilled to purify the chemicals. The distillate may be remelted for homogenization and spun at about 2500 rpm. During cooling, viscosity increased and a tube is formed and removed from the ampoule at room temperature. The tube may be subsequently drawn into micro-tubes. The micro-tubes may be stacked around a mold and subsequently heated to about 180° C. for about 2 hours to create a fused rod or tube having a microstructured architecture. The micro-tubes may also be formed by extrusion.

The rod may be telescopically inserted within the cavity of a first tube and heated until fused. Prior to assembly, the rod and tubes may be cleaned with any conventional cleaning solution. Alternatively, during heating, a drying gas may be released in the furnace to chemically clean the rod and tube during fusion. The resultant rod-tube complex may be subsequently inserted within another chalcogenide glass tube and heated until fused to create a double-clad optical fiber. If desired, this complex may be further inserted within and fused to additional chalcogenide tubes in the same manner to form optical fibers having 3 or more claddings. Optionally, the complex may be subsequently clamped in a fiber drawing device, heated to a suitable temperature and subsequently drawn into a micro-cane having a diameter less than about 10 mm, preferably, less than about 5 mm. The resultant micro-cane may then be telescopically inserted within and fused to additional chalcogenide tubes in the same manner to form optical fibers having 2 or more claddings. The cavity of the tubes may be centered or off-centered to fabricate concentric claddings, asymmetrical claddings or combinations thereof. The fused rod-tube complex may be subsequently clamped in a fiber drawing device, heated to a suitable temperature and subsequently drawn or extruded into a fiber. In one exemplary embodiment, the heating and fusing step may occur concurrently with fiber drawing.

Alternatively, multi-clad optical fiber 100 may be fabricated using a multi-crucible method that involves providing a multi-crucible apparatus, such as a double, triple-crucible or quad-crucible. The inner most first crucible is used to form the core, a second crucible surrounding the first crucible is used to form the first cladding and a third crucible surrounding the second crucible may be used to form the second cladding. Additional crucibles may be added to construct an optical fiber including 3 or more claddings. Each crucible may have a tip with an orifice aligned about a center point for drawing the fiber. In an exemplary embodiment, the tips and orifices are concentrically aligned, asymmetrically aligned or any combination thereof. The first, second and third crucible may be charged with the chalcogenide glass materials used to fabricate the core, first cladding and second cladding, respectively. The crucible apparatus may be subsequently heated to soften the glass and initiate flow from the orifices, and the fiber may be drawn from the crucible using any drawing apparatus, such as rollers.

The resultant multi-clad optical fiber 100 of the present invention has substantially enhanced optical properties and durability relative to the optical fibers of the prior art. Specifically, the chalcogenide glass composition of core 1, first cladding 3 and one or more subsequent claddings as well as the multi-clad structure of optical fiber 100 enables the transmission of light at two or more different wavelengths. This feature of the invention may be particularly advantageous in applications where the light is launched at different numerical apertures and spot sizes that correspond to the different numerical apertures and spot sizes of core 1, first cladding 3 and subsequent claddings. Therefore, the progressively decreasing refractive indexes of first chalcogenide cladding 3 and one or more subsequent chalcogenide claddings may be capable of transmitting light over a wide range of wavelengths, including both visible as well as infrared wavelengths, such as the near infrared, short infrared, mid-infrared and/or long infrared range.

The multi-clad structure of optical fiber 100 also provides a number of additional benefits. The outermost cladding effectively and efficiently traps light scattered from the core 1 within the lower cladding layers. This prevents interactions between the light and protective sheath that would otherwise melt or comprise the structural integrity of the protective sheath and multi-clad optical fiber 100. Additionally, the multiple cladding structure, in combination with the rare earth doped core 1, enables optical fiber 100 to be formed into a laser. The multi-clad structure allows pumped light to be launched into one or more undoped chalcogenide glass inner claddings; the light then interacts and is absorbed by the core 1. Laser emission from the rare earth dopant may then travel in the fiber core 1.

It is envisioned the multi-clad optical fiber 100 of the present invention may be used for a wide variety of applications in the field of optics and semiconductors. Specifically, it is expected that the invention may be particularly suitable for constructing inferred transmitting lasers and optical sensors.

### EXAMPLES

### Example 1

FIG. 1 shows an exemplary triple-clad chalcogenide fiber 100 having a solid chalcogenide glass core 1 composed of arsenic sulfide glass containing approximately 39 and about 61 molar percent arsenic and sulfur, respectively and having a refractive index of about 2.387. A first microstructured cladding 3 composed of arsenic sulfide glass containing approximately 38 and 62 molar percent arsenic and sulfur respectively and having a refractive index of about 2.369 is disposed about core 1. The first cladding has an air fill fraction of about 55% and an effective refractive index of about 1.61. A second solid cladding 5 composed of arsenic sulfide glass containing approximately 38.5 and 62.5 molar percent arsenic and sulfur, respectively and having a higher refractive index of about 2.384 is disposed about first cladding 3 to facilitate light stripping. A third solid cladding 25 composed of arsenic sulfide glass containing approximately 38 and 62 molar percent arsenic and sulfur, respectively and having a refractive index of about 2.369 surrounds second cladding 5 to enhance the structural integrity of the triple-clad optical fiber 100. The triple-clad chalcogenide fiber 100 was fabricated by extrusion and tube stacking.

### Example 2

FIG. 2 shows an exemplary double-clad chalcogenide fiber 100 having a solid chalcogenide glass core 1 composed of arsenic selenide containing approximately 39 and 61 molar percent arsenic and selenium, respectively and having a refractive index of about 2.79. A solid first cladding 3 composed of arsenic selenide containing approximately 38.5 and 61.5 molar percent arsenic and selenium, respectively and having a refractive index of about 2.78 is disposed about core 1. A second solid cladding 5 composed of arsenic selenide containing approximately 38 and 62 molar percent arsenic and selenium, respectively and having a lower refractive index of about 2.76 is disposed about first cladding 3.

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A multi-clad optical fiber comprising:
a core comprising a first chalcogenide glass;
a first cladding disposed about said core, wherein said first cladding comprises a second chalcogenide glass; and
at least a second cladding disposed about said first cladding.

2. The optical fiber of claim 1, wherein said multi-clad optical fiber transmits light over a range of wavelengths of from about 0.8 μm to about 14 μm.

3. The optical fiber of claim 1, wherein said second cladding comprises a third chalcogenide glass.

4. The optical fiber of claim 1, wherein said first chalcogenide glass or said first or second cladding comprises a dopant.

5. The optical fiber of claim 4, wherein said dopant is selected from the group consisting of: gallium, rare earth elements and transition metals.

6. The optical fiber of claim 1, wherein said first cladding further comprises a plurality of openings.

7. The optical fiber of claim 6, wherein said second cladding comprises a plurality of openings.

8. The optical fiber of claim 1, wherein said first or second cladding comprises a substantially solid chalcogenide glass.

9. The optical fiber of claim 1, wherein said fiber comprises a third cladding.

10. The optical fiber of claim 9, wherein said second cladding comprises a plurality of openings.

11. The optical fiber of claim 9, wherein said third cladding comprises a plurality of openings.

12. The optical fiber of claim 11, wherein said third cladding comprises a third chalcogenide glass.

13. The optical fiber of claim 1, wherein said first chalcogenide glass has a greater refractive index than said second chalcogenide glass and said second chalcogenide glass has a greater refractive index than said second cladding.

14. The optical fiber of claim 1, wherein said first chalcogenide glass has a greater refractive index than said second chalcogenide glass and said second chalcogenide glass has a lower refractive index than said second cladding.

15. The optical fiber of claim 1, further comprising a protective sheath disposed about the exterior surface of said multi-clad optical fiber, and wherein said protective sheath comprises a polymer.

16. A multi-clad optical fiber comprising:
a core comprising a first chalcogenide glass and an opening;
a first cladding disposed about said core, wherein said first cladding comprises a second chalcogenide glass; and
a second cladding disposed about said first cladding, wherein said second cladding comprises a third chalcogenide glass and wherein said second cladding has a lower refractive index than said first cladding.

17. The optical fiber of claim 16, wherein said first cladding further comprises a plurality of openings.

18. The optical fiber of claim 16, wherein said second cladding comprises a substantially solid chalcogenide glass.

19. The optical fiber of claim 16, wherein said third cladding comprises a plurality of openings.

20. The optical fiber of claim 16, further comprising a protective sheath disposed about the exterior surface of said multi-clad optical fiber, and wherein said protective sheath comprises a polymer.
